(19) United States
(12) Patent Application Publication
(10) Pub. No.: US 2024/0351452 A1
(43) Pub. Date: Oct. 24, 2024

(54) ACCESS TO VEHICLE WITH LOW STATE OF CHARGE BATTERY

(71) Applicant: FORD GLOBAL TECHNOLOGIES, LLC, Dearborn, MI (US)

(72) Inventors: David Celinske, Wolverine Lake, MI (US); Stuart C. Salter, White Lake, MI (US); Zeljko Deljevic, Plymouth, MI (US); John Anthony DeMarco, Lake Orion, MI (US); Andrew Hudson, Canton, MI (US); Chaitra Podali Mahesh, Dallas, TX (US); Vincent John Boscheratto, Allen Park, MI (US)

(21) Appl. No.: 18/305,001

(22) Filed: Apr. 21, 2023

(51) Int. Cl. B60L 50/60; B60Q 9/00; F16H 61/20

(52) U.S. Cl. CPC B60L 50/60; B60Q 9/00; F16H 61/20; B60L 2240/54; B60L 2270/00; B60R 25/22; B60R 25/23; B60R 25/24; F16H 2061/207

(57) ABSTRACT

One or more controllers, responsive to detecting a voltage at a jump start power input of a vehicle, attempt activation of a secondary power converter of the vehicle, and responsive to the activation of the secondary power converter being unsuccessful, attempt activation of a primary power converter of the vehicle.

### TECHNICAL FIELD

This disclosure relates to automotive power systems.

### BACKGROUND

An automotive vehicle may include several energy storage devices, such as batteries, ultra-capacitors, etc. Systems responsible for permitting access to such a vehicle responsive to user requests may require electrical power to operate. This electrical power may be sourced from the energy storage devices.

### SUMMARY

A vehicle includes a traction battery, primary and secondary power converters electrically connected with the traction battery, and one or more controllers. The one or more controllers, responsive to detecting voltage at a jump start power input, attempt activation of the secondary power converter, and responsive to the activation of the secondary power converter being unsuccessful, attempt activation of the primary power converter.

A method for a vehicle includes, responsive to an unsuccessful attempt to activate a secondary power converter that is connected with a traction battery followed by an unsuccessful attempt to activate a primary power converter that is connected with the traction battery while a voltage is present at a jump start power input, shifting a transmission into neutral.

A system of a vehicle includes one or more controllers that, responsive to unsuccessful attempts to activate a secondary power converter that is connected with a traction battery and a primary power converter that is connected with the traction battery while a voltage is present at a jump start power input, enable a keypad, card reader, or electronic latch.

### BRIEF DESCRIPTION OF THE DRAWINGS

FIG. 1 is a block diagram of a vehicle.

FIG. 2 is a flow chart of an algorithm for operating the vehicle of FIG. 1 during an attempt to jump start the vehicle of FIG. 1.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Some automotive electrical systems have become more complex within the context of electric and hybrid vehicles. These vehicles, in certain arrangements, can have two types of batteries: a high-voltage traction battery that among other things powers an electric machine, and a 12-volt battery that powers accessories loads, such as lighting, entertainment systems, and air conditioners. To manage power flow of these batteries and operation of the vehicle, primary and backup DC/DC converters may be used.

The traction battery in an electric vehicle is typically a high-voltage, high-capacity battery pack that can deliver a large amount of energy to power the electric machine. These batteries are typically made up of multiple lithium-ion cells, which are connected in series to provide the required voltage. The voltage of these batteries can range, for example, from 200V to 800V, depending on vehicle design. Because of the high voltage of these batteries, they are often not directly used to power accessory loads, which may require a 12-volt supply.

The 12-volt battery in a hybrid or electric vehicle is typically a standard lead-acid battery, similar to the battery used in conventional vehicles. This battery provides power to the vehicle's electrical systems. It can also be used to power the vehicle's electronic control modules (centralized or distributed) that manage operation of the transmission and other components.

To manage power flow associated with these types of batteries, multiple DC/DC power converters (e.g., a primary DC/DC converter, a backup or protected DC/DC converter, etc.) may be used. The primary DC/DC converter may (but need not be) located in proximity to the traction battery and convert the high voltage of the traction battery to 12-volt DC voltage (or other voltage) required by the vehicle's electrical systems. These converters may be designed to operate efficiently, with minimal power loss, to ensure the vehicle's electrical systems are supplied with the correct voltage.

The backup DC/DC converter may be used to maintain power to the vehicle's electrical systems in certain circumstances, such as when the primary DC/DC converter is unavailable or not operational. This backup converter may (but need not be) located in a vicinity of the 12-volt battery. Similar to the primary DC/DC converter, it may be designed to operate efficiently, with minimal power loss, to ensure the vehicle's electrical systems are supplied with the correct voltage.

The primary and backup DC/DC converters may be controlled by an electronic control module that monitors the battery levels and power requirements of the vehicle. The electronic control module may also manage charging of the batteries, ensuring they are charged to the correct level and preventing overcharging or undercharging.

In addition to the primary and backup DC/DC converters, hybrid and electric vehicles may also have other power management systems, such as regenerative braking systems. These systems capture energy from the vehicle's kinetic energy during braking and use it to charge the traction battery.

There may be circumstances in which the state of charge of the 12-volt battery is not sufficient to power systems responsible for permitting access to the vehicle. So-called jump starting the vehicle can be performed to enable access. There are several ways to jump start an electric vehicle depending on its design and manufacture. A jump starter pack, for example, could be used. Some starter packs are specifically designed for electric vehicles. These packs have cables and connectors that allow one to jump start the electric vehicle using the power stored in the pack. Another electric vehicle could also be used. The two vehicles may be connected together using appropriate jumper cables, so that power from one vehicle can be used to jump start the other. A portable charger or wall mounted charger are also potential options.

Certain vehicles may include a fascia door or other access point through which jumper cables or other such electrical connectors are routed and connected for the purpose of introducing a 12-volt potential on access terminals (battery power input) of vehicle electrical infrastructure for jumping purposes.

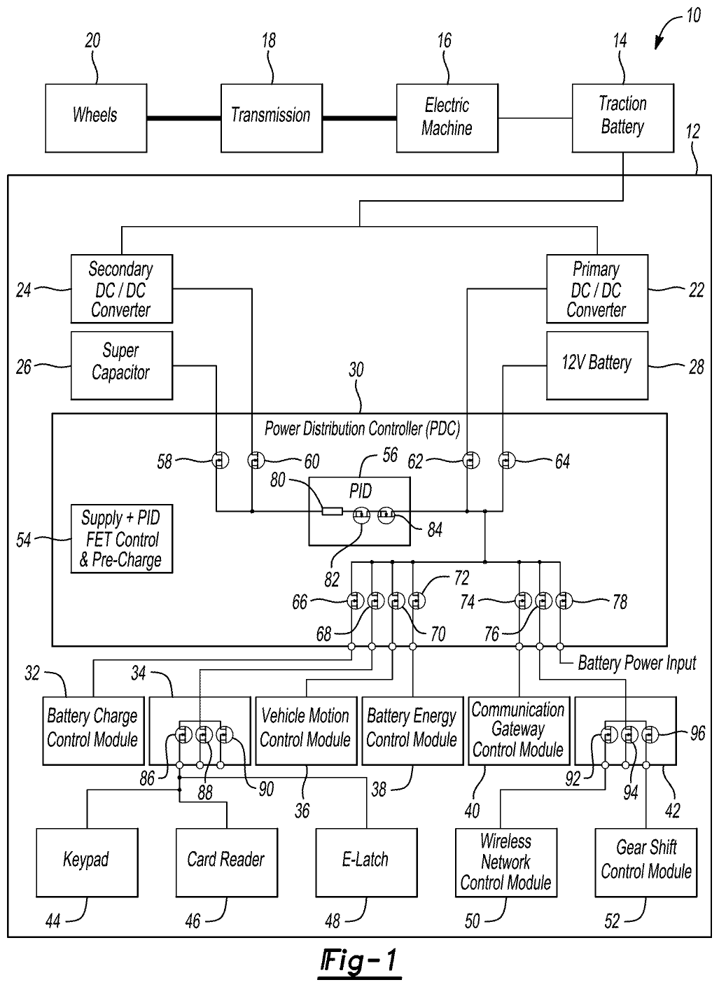

Referring to FIG. 1, an automotive vehicle 10 includes electrical infrastructure 12, a traction battery 14, an electric machine 16, a transmission 18, and wheels 20. Electrical power from the traction battery 14 may be supplied to the electric machine 16 for conversion to mechanical power. This mechanical power may be transferred via the transmission 18 to the wheels 20 to propel the vehicle 10. Mechanical power from the wheels 20 may be transferred via the transmission 18 to the electric machine 16 for conversion to electrical power and subsequent storage in the traction battery 14.

The electrical infrastructure 12 includes a primary DC/DC converter 22, a secondary (backup) DC/DC converter 24, a super capacitor 26, a 12-volt battery 28, a power distribution controller 30, a battery charge control module 32, a driver door zonal control module 34, a vehicle motion control module 36, a battery energy control module 38, a communication gateway control module 40, a center console zonal control module 42, a keypad 44, a card reader 46, an electronic latch 48, a wireless network control module 50, and a gear shift control module 52.

The power distribution controller 30 includes a supply and powernet isolation device field effect transistor and pre-charge control module 54, a powernet isolation device 56, and field effect transistors 58, 60, 62, 64, 66, 68, 70, 72, 74, 76, 78. The powernet isolation device 56 includes a shunt 80 and field effect transistors 82, 84, which are connected in series. The supply and powernet isolation device field effect transistor and pre-charge control module 54 (or another control module or modules) may exert control over the field effect transistors 58, 60, 62, 64, 66, 68, 70, 72, 74, 76, 78, 82, 84.

The driver door zonal control module 34 includes field effect transistors 86, 88, 90. The center console zonal control module 42 includes field effect transistors 92, 94, 96.

The traction battery 14 is connected with the primary and secondary DC/DC converters 22, 24. The primary DC/DC converter 22 is connected with the field effect transistor 84 via the field effect transistor 62. The secondary DC/DC converter 24 is connected with the shunt 80 via the field effect transistor 60. The super capacitor 26 is connected with the shunt 80 via the field effect transistor 58. The 12-volt battery 28 is connected with the field effect transistor 84 via the field effect transistor 64.

The battery charge control module 32 is connected with the field effect transistor 84 via the field effect transistor 66. The door zonal control module 34 is connected with the field effect transistor 84 via the field effect transistor 68. The vehicle motion control module 36 is connected with the field effect transistor 84 via the field effect transistor 70. The battery energy control module 38 is connected with the field effect transistor 84 via the field effect transistor 72. The communication gateway control module 40 is connected with the field effect transistor 84 via the field effect transistor 74. The center console zonal control module 42 is connected with the field effect transistor 84 via the field effect transistor 76. The battery power input is connected with the field effect transistor 84 via the field effect transistor 78.

The keypad 44, card reader 46, and electronic latch 48 are connected with the power distribution controller 30 via the field effect transistor 86.

The wireless network control module 50 is connected with the power distribution controller 30 via the field effect transistor 92. The gear shift control module 52 is connected with the power distribution controller 30 via the field effect transistor 96.

Depending on which of the field effect transistors 58, 60, 62, 64, 66, 68, 70, 72, 74, 76, 78, 82, 84 are activated, power from the traction battery 14 (via the primary and/or secondary DC/DC converters 22), super capacitor 26, and/or 12-volt battery 28 can be transferred to the battery charge control module 32, driver door zonal control module 34, vehicle motion control module 36, battery energy control module 38, communication gateway control module 40, and/or center console zonal control module 42. If the field effect transistors 62, 70, 72, 74 are activated, power from the traction battery 14 may flow through the primary DC/DC converter 22 and power distribution controller 30 to the vehicle motion control module 36, battery energy control module 38, and communication gateway control module 40.

As mentioned above, there may be circumstances in which the state of charge of the 12-volt battery 28 is too low. A user may thus apply a 12-volt potential on the battery power input (jump start power input) to jump the vehicle 10. The supply and powernet isolation device field effect transistor and pre-charge control module 54 (or other controller), responsive to detecting presence of the potential on the battery power input, may initiate the following procedure.

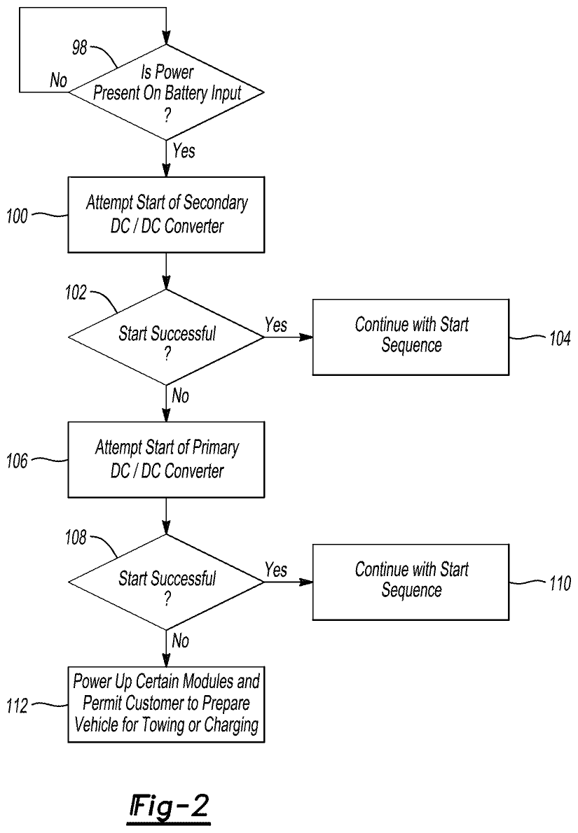

Referring to FIGS. 1 and 2, it is determined at operation 98 whether power is present on a battery input. The power distribution controller 30 may detect via sensors whether a voltage potential is present on a battery power input. Connection of jump start equipment for the vehicle 10 with the battery power input would result in application of voltage (e.g., 12V) to the battery power input. Presence of such voltage thus suggests that jump start equipment is connected, particularly when voltage is absent at inputs to the power distribution controller 30 associated with the primary and secondary DC/DC converters, 22, 24, the 12-volt battery 28, etc. Absence of such voltage thus suggests that jump start equipment is not connected. If no, the algorithm returns to operation 98. If yes, start of a secondary DC/DC converter is attempted at operation 100. The power distribution controller 30 may close appropriate field effect transistors (e.g., field effect transistors 60, 82, 84, etc.) to apply 12V to an input pin of the secondary DC/DC converter 24. This results in power-up of the secondary DC/DC converter 24 as known in the art provided it is not faulty. The current associated with this operation may be approximately 1A. If the power distribution controller 30 detects issues via diagnostic operations that suggest insufficient power is present to attempt activation of the secondary DC/DC converter 24, it may activate the super capacitor 26 prior to operation of the powernet isolation device 56 to facilitate an attempt to activate the secondary DC/DC converter 24.

At operation 102, it is determined whether start of the secondary DC/DC converter was successful. Proper operation of the secondary DC/DC converter 24 following the activation attempt would result in power being present on predefined pins of the secondary DC/DC converter 24 as known in the art. The power distribution controller 30 via monitoring of these predefined pins can determine whether power indicative of proper operation is present. If yes, a normal start sequence is continued at operation 104. The secondary DC/DC converter 24 provides power from the traction battery 14 to various of the battery charge control module 32, driver door zonal control module 34, vehicle motion control module 36, battery energy control module 38, communication gateway control module 40, center console zonal control module 42, keypad 44, card reader 46, electronic latch 48, wireless network control module 50, and gear shift control module 52. A user may thus gain access to the vehicle 10 and drive the same several miles using power from the traction battery 14 to propel the vehicle 10 via the electric machine 16, transmission 18, and wheels 20. If no, start of a primary DC/DC converter is attempted at operation 106. The power distribution controller 30 may close appropriate field effect transistors (e.g., field effect transistors 62, 82, 84, etc.) to apply 12V to an input pin of the primary DC/DC converter 22. This results in power-up of the primary DC/DC converter 22 as known in the art provided it is not faulty. The power distribution controller 30 may also close appropriate field effect transistors (e.g., field effect transistors 70, 72, 74) to apply 12V to the vehicle motion control module 36, battery energy control module 38, and communication gateway 40, as well as other modules, to prepare the same for powering of the vehicle 10 via the primary DC/DC converter 22 and traction battery 14.

| At operation 108, it is determined whether start of the primary DC/DC converter was successful. Proper operation of the primary DC/DC converter 22 following the activation attempt would result in power being present on predefined pins of the primary DC/DC converter 22 as known in the art. The power distribution controller 30 via monitoring of these predefined pins can determine whether power indicative of proper operation is present. If yes, a normal start sequence is continued at operation 110. The primary DC/DC converter 22 provides power from the traction battery 14 to various of the battery charge control module 32, driver door zonal control module 34, vehicle motion control module 36, battery energy control module 38, communication gateway control module 40, center console zonal control module 42, keypad 44, card reader 46, electronic latch 48, wireless network control module 50, and gear shift control module 52. A user may thus gain access to the vehicle 10 and drive the same several miles using power from the traction battery 14 to propel the vehicle 10 via the electric machine 16, transmission 18, and wheels 20. If no, certain modules are powered up and the user is permitted to prepare the vehicle for towing or charging at operation 112. The power distribution controller 30 may close appropriate field effect transistors (e.g., field effect transistors 66, 68, 70, 74, 76, 86, 92, 96) to apply 12V to the battery charge control module 32, driver door zonal control module 34, vehicle motion control module 36, communication gateway control module 40, center console zonal control module 42, keypad 44, card reader 46, electronic latch 48, wireless network control module 50, and gear shift control module 52. The user may thus gain access to the vehicle 10. The power distribution controller 30 may further generate output, and communicate the same via the communication gateway control module 40, for display and/or play to the user indicating the user has the option to prepare the vehicle 10 to be towed or readied for charge. The user may input their selection via the keypad 44 or other input device (e.g., phone, display screen, etc.). If the user selects towing, the power distribution controller 30 (in possible coordination with other controllers) may generate commands to shift the transmission 18 into neutral via the gear shift control module 52, as well as release any electronic parking brakes. The power distribution controller 30 may then generate and communicate output for display and/or play indicating the vehicle 10 is ready to be towed. If the user selects charging, the power distribution controller 30 (again in possible coordination with other controllers) may generate commands to unlatch a charge port panel (also represented by the traction battery 14) and enable modules and circuitry (e.g., high voltage bus contactors, etc.) needed to permit charging of the traction battery 14. The power distribution controller 30 may then generate and communicate output for display and/or play indicating the vehicle 10 is ready for charging.

The power distribution controller 30 may also, at different times, generate and communicate output for display and/or play that provides further instructions and/or details regarding the jump start process and related activities. This output may indicate the state of the traction battery 14, an estimated available travel distance given the state of charge of the traction battery 14, suggestions for a nearest service station, reminders to close the battery power input access panel, etc. This information can help inform and guide the user during the above described processes.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a traction battery;
primary and secondary power converters electrically connected with the traction battery; and
one or more controllers programmed to, responsive to detecting voltage at a jump start power input, attempt activation of the secondary power converter, and responsive to the activation of the secondary power converter being unsuccessful, attempt activation of the primary power converter.

2. The vehicle of claim 1 further comprising a transmission, wherein the one or more controllers are further programmed to, responsive to the activation of the primary power converter being unsuccessful, command a shift of the transmission to neutral.

3. The vehicle of claim 2, wherein the command is further responsive to user input.

4. The vehicle of claim 2, wherein the one or more controllers are further programmed to generate output for a user indicating the vehicle is ready to be towed.

5. The vehicle of claim 1, wherein the one or more controllers are further programmed to, responsive to the activation of the primary power converter being unsuccessful, command a charge port latch to open.

6. The vehicle of claim 5, wherein the command is further responsive to user input.

7. The vehicle of claim 5, wherein the one or more controllers are further programmed to generate output for a user indicating the vehicle is ready to be charged.

8. The vehicle of claim 1, wherein the one or more controllers are further programmed to, responsive to the activation of the primary power converter being unsuccessful, enable a keypad, card reader, or electronic latch.

9. The vehicle of claim 1, wherein the one or more controllers are further programmed to, responsive to the detecting, activate a super capacitor.

10. The vehicle of claim 1, wherein the one or more controllers are further programmed to, responsive to the detecting, generate output for a user related to the traction battery or the jump start power input.

11. A method for a vehicle comprising:
responsive to an unsuccessful attempt to activate a secondary power converter that is connected with a traction battery followed by an unsuccessful attempt to activate a primary power converter that is connected with the traction battery while a voltage is present at a jump start power input, shifting a transmission into neutral.

12. The method of claim 11, wherein the shifting is further responsive to user input.

13. The method of claim 11 further comprising generating output for a user related to the shifting.

14. The method of claim 11 further comprising enabling a keypad, card reader, or electronic latch.

15. The method of claim 11 further comprising sequentially attempting to activate the secondary and primary power converters while the voltage is present.

16. A system of a vehicle, comprising:
one or more controllers programmed to, responsive to unsuccessful attempts to activate a secondary power converter that is connected with a traction battery and a primary power converter that is connected with the traction battery while a voltage is present at a jump start power input, enable a keypad, card reader, or electronic latch.

17. The system of claim 16, wherein the one or more controllers are further programmed to, responsive to the unsuccessful attempts, shift a transmission to neutral.

18. The system of claim 17, wherein the shift is further responsive to user input.

19. The system of claim 16, wherein the one or more controllers are further programmed to, responsive to the unsuccessful attempts, unlatch a charge port.

20. The system of claim 16, wherein the one or more controllers are further programmed to, responsive to the unsuccessful attempts, permit charging of the traction battery.
